(19) United States
(12) Patent Application Publication
(10) Pub. No.: US 2005/0114093 A1
(43) Pub. Date: May 26, 2005

(54) Method and apparatus for motion estimation using variable block size of hierarchy structure

(75) Inventors: Sang-chang Cha, Hwaseong-si (KR); Jong-hak Ahn, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/986,384

(22) Filed: Nov. 12, 2004

(30) Foreign Application Priority Data
Nov. 12, 2003 (KR) 10-2003-0079918

(51) Int. Cl. G06F 11/30

(52) U.S. Cl. 702/189

(57) ABSTRACT

Disclosed is a method and apparatus for a motion estimation using a variable block size of a hierarchy structure. The method includes: calculating each of a motion vector of a desired minimum unit variable block; determining a similarity of the calculated motion vectors between the minimum unit variable blocks in a higher hierarchy including the minimum unit variable block; establishing a mode of the variable block according to the determined similarity; and deciding a motion vector with respect to the mode established variable block. The complexity of the method of compressing a motion picture of a hierarchy structure having a plurality of block sizes can be reduced by selecting a mode of the optimal block size on the basis of a motion vector with respect to the minimum unit and the cost occurred at that time without performing the motion estimation with respect to each mode each time.

This application claims priority of Korean Patent Application No. 10-2003-0079918 filed on Nov. 12, 2003, in the Korean Intellectual Property Office, the disclosure of which is incorporated herein in its entirety by reference.

### BACKGROUND OF THE INVENTION

1. Field of the Invention

The present invention is related to a method and apparatus for a motion estimation using a variable block size of a hierarchy structure. More specifically, the present invention is related to a method and apparatus for a motion estimation, wherein, for a motion estimation and compensation method, the amount of calculation for a motion vector can be reduced and a search region can be narrowed by deciding a mode of a variable block of a higher hierarchy, by determining a similarity of motion vectors of the minimum unit blocks using a method suggested in the present invention, and deciding a motion vector of a variable block of the corresponding mode.

2. Description of the Related Art

A basic principle of data compression is a process for removing data redundancy. Data can be compressed by removing spatial redundancy such as the repetition of the same color or object in an image, temporal redundancy such as a case that there are few changes between adjacent frames with the lapse of time in a motion picture frame or continuous repetition of the same audio sound, or psychological visual redundancy in consideration that human visibility and sensibility are dull to a high frequency. The data compression schemes are classified into a lossy compression scheme and a lossless compression scheme according to whether source data suffer a loss or not, an intra-frame compression scheme and an inter-frame compression scheme according to whether each frame is compressed independently or not, and a symmetrical compression scheme and a non-symmetrical compression scheme according to whether the time needed to perform compression and decompression are the same or not. Besides those, there is a case where a time needed to perform compression and decompression is not over 50 ms, which is classified into a real-time compression scheme and a case classified into a scalable compression scheme, where the resolutions of frames are different from one another. The lossless compression is used in the case of textual data or medical data since all information is important, and the lossy compression is mostly used in the case of multimedia data. The intra-frame compression is used to remove the spatial redundancy and the inter-frame compression is used to remove the temporal redundancy.

Most of the current video coding standards including MPEG-2, MPEG-4, H.263 and H.264 are based on a motion-compensated prediction-coding scheme, wherein the temporal redundancy is removed by motion compensation and the spatial redundancy is removed by a transformation coding.

Reviewing a process to remove the temporal redundancy in detail, a motion estimation to obtain a motion vector is performed, which indicates how long a constructional unit of a frame, for example each macro block, moves to a corresponding macro block in a frame that occurs next in time. After finishing the motion estimation, the temporal redundancy between frames is removed through temporal filtering by performing the motion compensation.

Such a process to remove the temporal redundancy needs a large number of calculations, and a large number of algorithms are suggested to reduce the number of calculations. Generally, there are a method for reducing the calculations by reducing the number of motion vector candidate points, a method for reducing a calculation of block matching cost, and a method for sub-sampling the motion vector.

On the other hand, MPEG1/2/4 in ISO (International Organization for Standardization) and H.261/H.263/H.26L in ITU (International Telecommunication Union) are currently widely used as a moving picture compression international standard. While the MPEG4 and H.26L are being used as standards targeting for application in a wireless communication environment of a low transmission rate, the MPEG in the ISO and VCEG in the ITU jointly constructed a JVT (Joint Video Team) and organized a moving picture compression standard of a low transmission rate, as drafted in March, 2003.

The title of the standard is called H.264 in the ITU, and MPEG-4 part 10 or AVC (Advanced Video Coding) in the ISO. The H.264 is a moving picture compression standard suitable for a network environment and has increased error resilience, which is aimed to enhance its compression rate more than 50% in comparison with the H.263 version 2 (H.263 plus) and MPEG-4 Advanced Simple Profile. Also, the H.264 has been adopted as a standard of DMB (Digital Multimedia Broadcasting) issued recently.

A compression scheme on a time axis used in a video compression scheme of the H.264 includes a variable block motion estimation scheme of a hierarchy structure wherein, in order to perform the optimal motion estimation, each motion vector and each cost required at that time in each mode are calculated, and each cost is compared with one another, so that a mode requiring the minimum cost is selected. That is, firstly, the optimal motion vector and its cost are calculated by performing the motion estimation with respect to a first mode. Secondly, the motion vector and its cost are calculated with respect to a second mode, and the calculated cost is compared with the cost calculated in the first mode so as to select a low cost mode. Thirdly, the second step is repeatedly performed for all modes to make a combination of modes requiring the least cost.

However, the greater the number of modes increases the more complicated the motion estimation algorithm becomes proportionally, since the optimal mode is calculated in the method as described.

A cost calculation method used generally in a motion estimation of the motion picture compression algorithm of a variable block size of the hierarchy structure is SAD (Sum of Absolute Difference), wherein a method for calculating the optimal motion vector is as follows.

First of all, with respect to a block of a predetermined size, a block of the same size in the previous frame and absolute values of different values between the previous frame and a current frame in each pixel are summed up and it is defined as the SAD. And then, all of the SAD with respect to the block of the predetermined size obtained in the method described above is searched for within a predetermined search-range in the picture of the previous frame. A relative position of the block in the previous frame generating the minimum SAD value among the blocks becomes the optimal motion vector.

Since the H.264 performs the searching process by interpolating of the value to ¼ pixel, different from the previous MPEG series, there occurs a problem in that the amount of calculation to find out the optimal motion vector increases by 4 times in comparison with ½ pixel searching, and it increases by 16 times in comparison with 1 pixel.

Especially, the more various block sizes the method uses the more the amount of the calculation increases. The H.264 uses various kinds of block types, that is, 7 modes in total when predicting the motion, and these modes can be again combined very differently, that is, actually 4 cases (16×16, 16×8, 8×16 and 8×8) in macro block (16×16) units and 4 more cases (8×8, 8×4, 4×8 and 4×4) with respect to each of four 8×8 blocks in the case that the modes are divided into 4 each having an 8×8 block size. That is, using this method, the SAD calculation required for motion estimation with respect to one pixel increases to as many as the number of the modes. It results in an increase in complication of the motion estimation 5 to 7 times in comparison with the algorithms of MPEG4 and MPEG2, which do not adopt this method. Accordingly, it is an important factor in the H.264 encoder to reduce, the amount of calculation in the process of searching for the optimal motion vector with respect to a large number of combinations.

Even though motion estimation plays a very important role in the performance of moving picture compression, it has a large amount of calculations so that an algorithm to decrease the amount of calculation for the motion estimation is needed for encoding a real-time moving picture. Especially, in case of performing a variable block motion estimation as in H.264, the motion estimation should be performed in each block size so that the amount of calculation increases still more and accordingly, a motion estimation algorithm to decrease the complication of the motion estimation is needed still more.

### SUMMARY OF THE INVENTION

It is an aspect of the present invention to provide a method and apparatus for motion estimation wherein, for a moving picture compression scheme, a complication may be largely reduced in a variable block compression algorithm of a hierarchy structure having a plurality of modes, by deciding a block mode having the optimal size on the basis of a motion vector of the minimum unit block without performing a motion estimation for each mode and predicting a motion of a higher hierarchy.

To achieve the aspect of the present invention, the present invention provides a method for a motion estimation using a variable block size of a hierarchy structure, the method comprising: a first step of calculating each of a motion vector of a desired minimum unit variable block; a second step of determining a similarity of the calculated motion vectors between the minimum unit variable blocks in a higher hierarchy including the minimum unit variable block; a third step of establishing a mode of the variable block according to the determined similarity; and a fourth step of deciding a motion vector with respect to the mode established variable block.

In an exemplary embodiment, the first step includes a first process of calculating a cost for the motion vector of the calculated minimum unit variable block; and a second process of storing the calculated motion vector and cost.

In an exemplary embodiment, the second step includes a first process of grouping the minimum unit variable blocks in the reverse order of size of the stored cost; and a second process of determining a similarity of the motion vectors between the grouped blocks. Also, when the motion vectors are similar as a result of the determination, the second step further includes a third process of determining a similarity of the motion vectors between the grouped blocks and other adjacent blocks having the same sizes as the grouped blocks again, the grouped blocks being used as a unit. Here, it is desirable that, in the determination of the similarity, the motion vectors are determined as similar when a vector difference of the motion vectors of the variable blocks being subjects of the determination of the similarity is less than or equal to a desired threshold.

In an exemplary embodiment, the third step is a step of establishing the mode of the variable blocks according to the determined similarity going down starting from the highest hierarchy to lower hierarchies.

In an exemplary embodiment, the fourth step is a step of deciding the motion vectors of the mode of the variable blocks established in the third step using the motion vectors of the lower hierarchy blocks constructing the block. Also, the fourth step is a step of deciding the motion vectors of the mode of the variable blocks established in the third step using an intermediate value of the motion vectors of the lower hierarchy blocks constructing the block.

In an exemplary embodiment, the method for a motion estimation to calculate the motion vector is a method for a high-speed motion estimation.

To achieve the aspect of the present invention, the present invention provides an apparatus for a motion estimation using a variable block size of a hierarchy structure, comprising: motion vector calculating means for calculating each of motion vectors of a desired minimum unit variable block; variable block mode establishment means for determining a similarity of the calculated motion vectors between the minimum unit variable blocks in a higher hierarchy including the minimum unit variable block, and establishing a mode of the variable block according to the determined similarity; and motion vector decision means for deciding the motion vector with respect to the mode established variable block.

In an exemplary embodiment, the motion vector calculating means calculates a cost for the motion vector of the calculated minimum unit variable block and stores the calculated motion vector and cost.

In an exemplary embodiment, the variable block mode establishment means makes a grouping of the minimum unit variable blocks in the reverse order of size of the stored cost, and determines a similarity of the motion vectors between the grouped blocks. And, it is desirable that the variable block mode establishment means determines a similarity of the motion vectors between the grouped blocks and other adjacent blocks having the same sizes as the grouped blocks again when the motion vectors are similar as a result of the determination, the grouped blocks being used as a unit.

In an exemplary embodiment, the variable block mode establishment means establishes the mode of the variable block according to the determined similarity going down starting from the highest hierarchy to lower hierarchies.

In an exemplary embodiment, the motion vector decision means decides the motion vector of the mode of the variable block established in the variable block mode establishment means using the motion vectors of the lower hierarchy blocks constructing the block. In an exemplary embodiment, the motion vector decision means decides the motion vector of the mode of the variable block established in the variable block mode establishment means using an intermediate value of the motion vectors of the lower hierarchy blocks constructing the block.

### BRIEF DESCRIPTION OF THE DRAWINGS

The above and other features and advantages of the present invention will become more apparent to those of ordinary skill in the art by describing in detail the exemplary embodiments thereof with reference to the attached drawings in which:

FIG. 1 is a block diagram showing a function of a moving picture compression apparatus of H.264;

FIG. 2A is a view showing a block size in accordance with a mode of the variable block of the hierarchy structure in H.264;

FIG. 2B showing an example in which a mode of a variable block is piled one upon another;

FIG. 3 is a block diagram of a motion estimation apparatus in accordance with an embodiment of the present invention;

FIG. 4 is a flow chart showing a motion estimation method in accordance with an embodiment of the present invention;

FIG. 5 is a flow chart showing a process for determining a similarity of a motion vectors in accordance with an embodiment of the present invention;

FIG. 6 is a view showing a process to establish a mode of a variable block in accordance with an embodiment of the present invention; and

FIG. 7 is a view showing a division of a block according to a mode of a variable block in accordance with an embodiment of the present invention.

### DETAILED DESCRIPTION OF THE INVENTION

The present invention will now be described more fully hereinafter with reference to the accompanying drawings, in which exemplary embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout the specification.

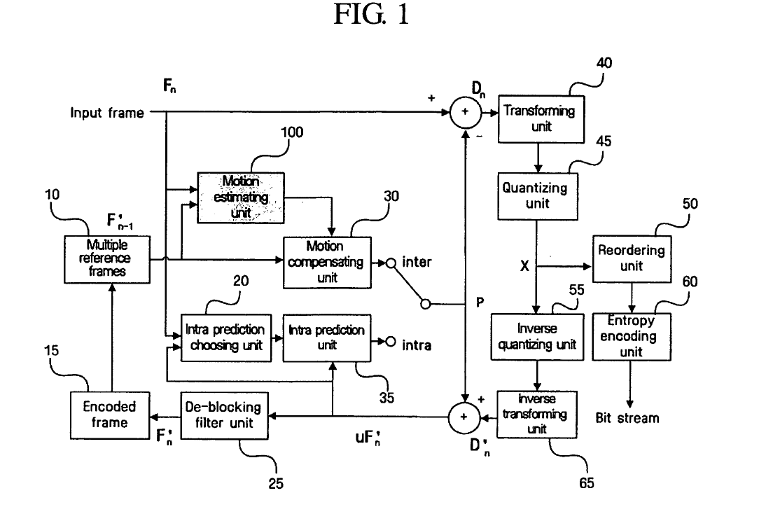

FIG. 1 is a block diagram showing a function of a moving picture compression apparatus of H.264.

An image of the moving picture in coding of the moving picture can be divided into a frame (intra-frame) compressed independently from other frames, and a frame (inter-frame) compressed on the basis of other frames. An I-frame in an MPEG moving picture compression corresponds to the former, and a P-frame compressed with reference to the I-frame or another P-frame and a B-frame which is made by interpolating two other frames correspond to the latter.

When removing temporal redundancy, temporal filtering is performed by making a motion estimation and compensating the estimated motion. On the other hand, there is no motion compensation process in an intra picture.

Hereinafter, an explanation will be briefly given to the functions of each function block of the H.264 moving picture compression apparatus shown in FIG. 1.

A motion estimating unit 100 and a motion compensating unit 30 perform an estimation of how long the picture has moved by comparing the picture of the previous frame and a picture of the current frame and finding out similar parts in each block, and then make a predicted picture by compensating the previous frame by the discovered movement. An intra-prediction choosing unit 20 and an intra-prediction unit 35 make a prediction of the picture of a new block on the basis of information of the adjacent block in the current frame.

A transforming unit 40 compresses a difference picture remaining after subtracting the predicted picture from the original picture into the DCT-based transform signal. A picture signal is transformed into a frequency domain using this transformation so that its distribution can be transformed into more visually important information and visually less important information.

A quantizing unit 45 performs actual data compression by dividing the transformed signal by a value of predetermined size and removing the visually less important information. Here, the higher the value of predetermined size becomes, the worse the quality of the picture becomes and the compression increases.

A reordering unit 50 distributes the picture signal in two dimensions, and the signals are concentrated on the left-top of screen in the course of the above transformation and quantization. Obtaining such a signal in zigzag in the direction of a diagonal line, while the signal becomes smaller as it goes to the right-bottom of the screen, most of signals become 0. Signals rearranged as described above have much more advantages than in an arrangement having 0 s intermediately in compression.

An entropy-encoding unit 60 performs lossless compression by transforming the rearranged signals in the reordering unit 50 into symbols in a predetermined rule.

Inverse-quantizing unit 55 and inverse-transforming unit 65 act as follows. An original picture is reconstructed when a decoder receives compressed pictures, and the compressed pictures suffer a loss when they are quantized in the encoder. The decoder receiving the pictures restrictively has only information on pictures damaged in proportion to the compression ratio. On the other hand, the encoder removes similar parts from a picture of the current frame on the basis of the information of the previous frame using a motion estimation/compensation method and an intra-prediction choosing/intra-prediction method. In this case, results of encoding and decoding are the same only when previously lost frame possessed by the decoder is used. Accordingly, the inverse-quantizing unit 55 and inverse-transforming unit 65 perform the inverse-quantization/inverse-transform performed in the decoder in the encoder in order to make the information of the previous frame, which has been lost and will be used in the motion estimating unit 100 and the motion compensating unit 30.

Since pictures are divided into block units and quantized, the higher the quantization coefficient value becomes the less continuous the picture signal becomes in the block boundary, and the picture may be viewed as a mosaic. Such a phenomenon is called a blocking artifact, and deblocking filter unit 25 enhances a subjective quality of the picture by removing it.

When similar parts are removed from the current frame on the basis of the data of the previous frame, its compression efficiency can be enhanced in case of referring to a plurality of previous frames. Therefore, multiple reference frames 10 have the plurality of the previous frames.

A flow of the compression performance of the encoder part will be explained on the basis of each functional unit.

An input frame (Fₙ) to be encoded is inputted, being constructed as a macro block unit having 16×16 pixels. Each macro block is encoded as an intra mode and an inter mode. A prediction macro block P is made on the basis of the reconstructed frame wherein it is made by a sample of the current frame n in the intra mode, and by a motion compensation prediction from one or more multiple reference frames in the inter mode.

Referring to FIG. 1, the reference frame is indicated as an encoded frame Fₙ₋₁′ in the previous stage. However, the prediction macro block P with respect to each macro block is formed of a plurality of previous or future frames which were encoded and reconstructed already.

The prediction macro block P is extracted from the current macro block and calculates a difference macro block Dₙ. Such a difference macro block Dₙ is transformed through the transforming unit 40, quantized through the quantizing unit 45, and then is used to generate a set of quantized transform coefficients X. Such quantized transform coefficients X are reordered by the reordering unit 50 and entropically encoded by the entropy encoding unit 60. The entropy-transform coefficients, together with additional information required to decode the macro block (such as the motion vector, the macro block prediction mode, and quantization step size which are used to indicate how the motion compensation of the macro block is performed) form a compressed bit stream. This is passed to a Network Abstraction Layer (NAL) for transmission or storage.

Reviewing an encoding process with respect to a path to be reconstructed, the quantized transform coefficients X are decoded in order to reconstruct a frame for encoding of further macro blocks. The coefficients X are dequantized and inversely transformed to calculate a difference macro block Dₙ′. This is discriminated from the original difference macro block Dₙ. The quantization process introduces losses and so Dₙ′ is a distorted version of the original difference macro block Dₙ. And then, the prediction macro block P is added to the Dₙ′ to create a reconstructed macro block uFₙ′. A deblocking filter unit 25 is applied to reduce effects of blocking distortion and a reconstructed reference frame is created from a series of macro blocks Fₙ′.

Spatial redundancy is removed by a transform, wherein the redundancy is removed by a discrete cosine transform in case of the MPEG, and by an integer transform in case of the H.264.

Even though the quantization reduces general accuracy of the integer coefficient, it is used to remove high frequency coefficients. Entropy coding in the H.264 uses a CABAC (Context Adaptive Binary Arithmetic Codes) scheme, that is, an adaptive probability model with respect to most of symbols.

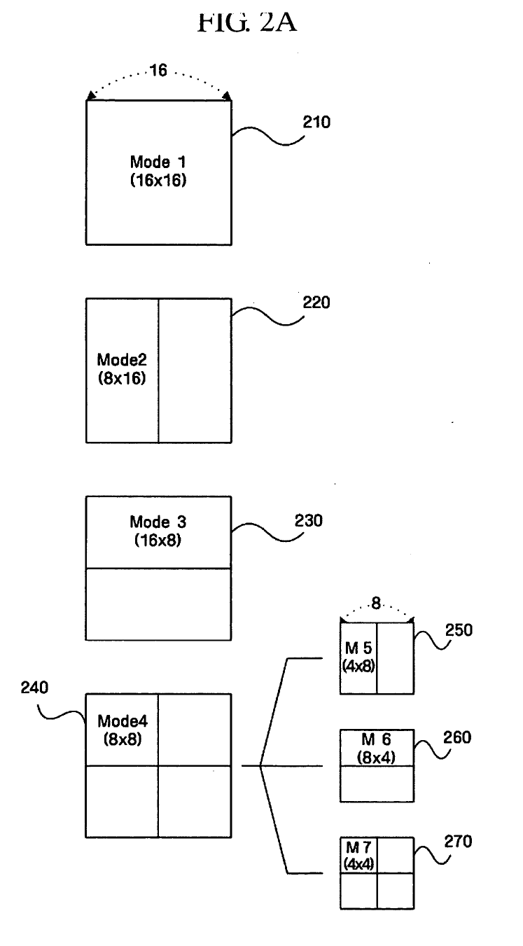

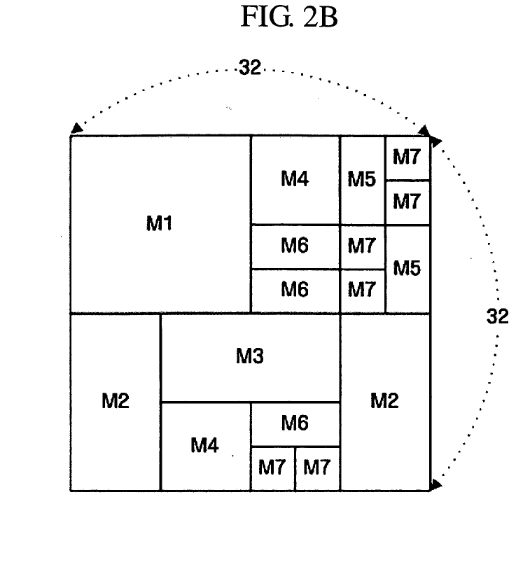

FIG. 2A is a view showing a block size in accordance with a mode of a variable block of a hierarchy structure in H.264.

Motion compensation in the H.264 is performed using a variable block of the hierarchy structure shown in FIG. 2A. In a motion estimation, each of the SAD values of 7 modes is obtained and a motion vector of the mode which has the minimum SAD value among them is obtained. A mode 1 (210), a mode 2 (220) and a mode 3 (230) can be selected in a macro block unit having a 16×16 size, and a mode 4 (240), mode 5 (250) and a mode 6 (260) can be selected in a macro block unit having an 8×8 size, and a mode 7 (270) can be selected in the minimum unit block having a 4×4 size.

A picture can be constructed in various modes as shown in FIG. 2B showing an example in which a mode of a variable block is piled one upon another. The mode 1 (210) is selected with respect to a background having little motion, and a higher mode is selected with respect to a point having a lot of motions. And, a bright part means a point where there are a lot of differences between two frames.

In order to perform the motion estimation using the H.264 standard, SAD values with respect to all minimum unit blocks (the mode 7) having a 4×4 size are obtained, SAD values with respect to sub-blocks of 4×8, 8×4, 8×8, 16×8, 8×16 and 16×16 are obtained by adding adjacent SAD values of a 4×4 size with one another, and both SAD values are compared. Such a method requires many calculations so that it can be a factor to increase time and cost of motion picture compression.

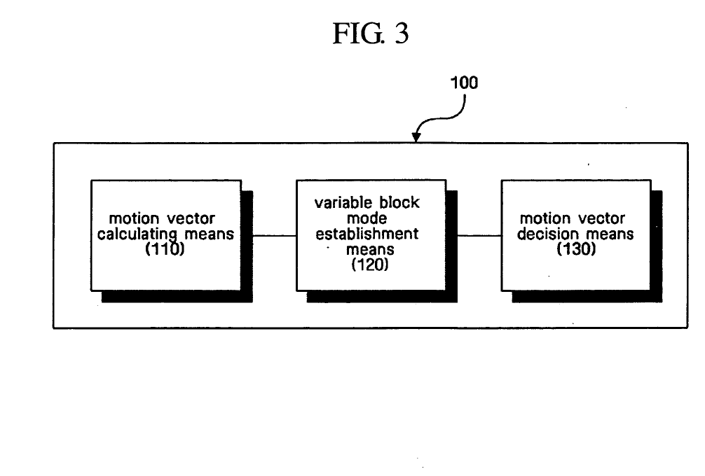

FIG. 3 is a block diagram of a motion estimation apparatus in accordance with one embodiment of the present invention.

The motion estimation apparatus can play a role as the motion estimation unit 100 in FIG. 1. Motion vector calculation means 110 calculates a motion vector for each of a desired minimum unit variable block. Variable block mode establishment means 120 determines a similarity of the motion vectors between the minimum unit variable blocks in the higher hierarchy including the minimum unit variable block, and plays a role to establish the mode of the variable block according to the determined similarity. And, motion vector decision means 130 plays a role to decide a motion vector with respect to a mode established variable block.

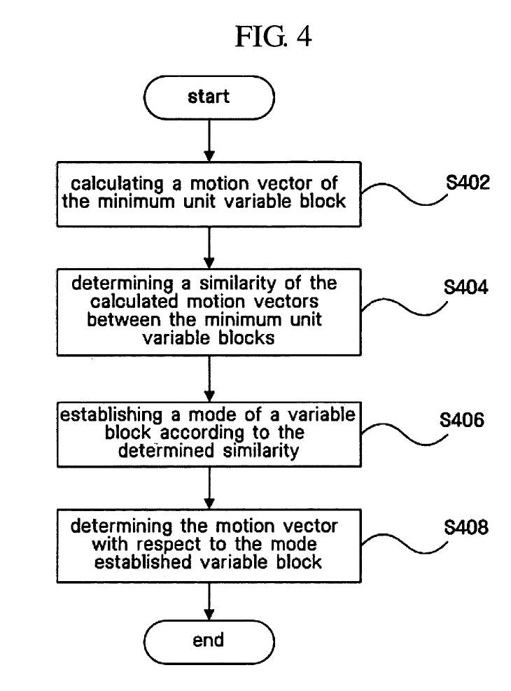

FIG. 4 is a flow chart showing a method for a motion estimation in accordance with an embodiment of the present invention.

At first, the motion vector calculating means 110 calculates a motion vector of the minimum unit variable block corresponding to the mode 7 having a 4×4 size (S402). And, a cost with respect to the calculated motion vector of the minimum unit variable block is calculated and the cost can be stored together with the calculated motion vector. In this case, the motion vector calculating means 110 may include a storage means for storing the calculated motion vector and the cost. Cost means the amount of bits occurring when a video picture is compressed using the calculated motion vector, and high cost means that more bits are required in the case that compression is performed using the corresponding motion vector and there is low compression efficiency.

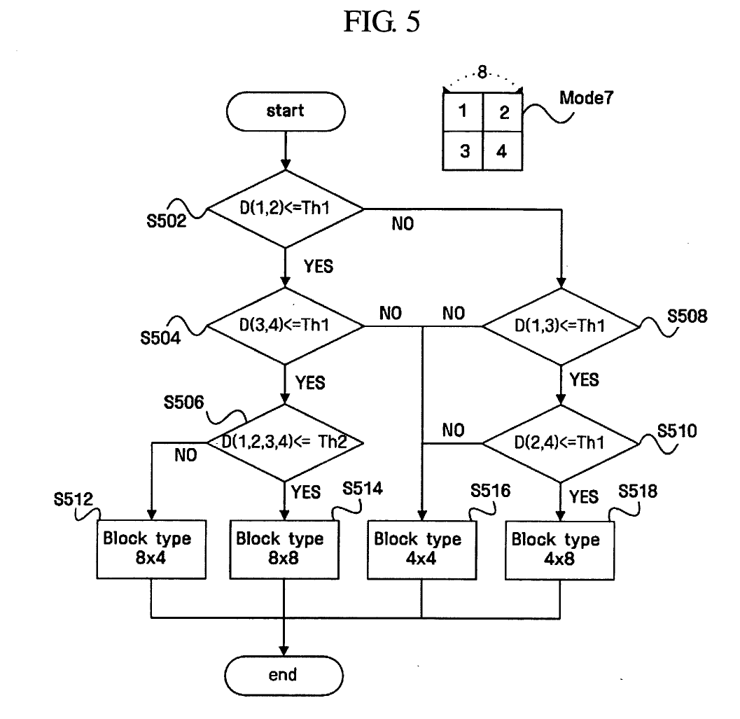

Next, a similarity of the calculated motion vectors between the minimum unit variable blocks in the higher hierarchy including the minimum unit variable block is determined (S404). A detailed process for the similarity determination includes a process of grouping the minimum unit variable blocks such that the probability of the magnitude of the stored cost becomes smaller, is high, and a process of determining the similarity of the motion vectors between the minimum unit blocks constructing the grouped block. According to the determination, when the compared motion vectors are similar, a process of determining the similarity of the motion vectors between the grouped blocks and other adjacent grouped blocks having the same size as the grouped blocks is performed again, the grouped blocks being used as a unit. Here, the similarity determination method determines that the motion vectors are similar when the vector difference of the motion vectors of the corresponding variable blocks which are subjects of a similarity determination is less than or equal to a desired threshold value. Hereinafter, the detailed process of the similarity determination of the motion vectors will be explained with reference to FIG. 5.

FIG. 5 is a flow chart showing a process of determining a similarity of motion vectors in accordance with an embodiment of the present invention.

An 8×8 sized block appearing on the upper right of FIG. 5 consists of 4 blocks of the minimum unit having a 4×4 size corresponding to the mode 7 (270). First of all, each of the motion vectors with respect to the minimum unit of 4 blocks is calculated. And then, a difference with respect to each of the motion vectors is compared with a desired threshold, wherein the motion vector is expressed as a vector difference since it is a vector quantity. Therefore, D, (block 1 and block 2) meaning a difference of the motion vector between the minimum unit blocks, is understood as a distance between the motion vector values. Giving it as an expression, when values of arbitrary two motion vectors are mv1 (x, y) and mv2 (x′, y′), the distance is SQRT {(x−x′)*(x−x′)+(y−y′)*(y−y′)}. (Here, SQRT means a function that extracts a square root).

Firstly, it is determined whether D (1, 2) being a difference between the motion vectors of blocks 1 and 2 is less than a desired threshold Th1 (S502). Here, the desired threshold is a value determined experimentally, which can be defined previously according to a quantized coefficient or assigned as an arbitrary value. When the D (1, 2) is less than the Th1, it means that the motion vectors of the two blocks are similar so that the blocks 1 and 2 can be combined as one block. That is, it can be corresponded to the block mode 6 having an 8×4 size.

When the D (1, 2) is less than the Th1, it is determined whether D (3, 4) being a difference between the motion vectors of the blocks 3 and 4 is less than the desired threshold Th1 (S504). When the D (3, 4) is less than the desired threshold Th1, similarity determinations are performed with respect to all of the blocks 1 to 4. That is, when D (1, 2, 3 and 4) is less than a desired threshold Th2, it means that the motion vectors of the 4 blocks are similar all together so that it is possible to make a block of the mode 4 which is a block type having an 8×8 size since it is possible to group the 4 blocks as one block (S514). However, when the D (1, 2, 3 and 4) is not less than the desired threshold Th2, the blocks 1 and 2 are also similar and blocks 3 and 4 are similar so that the 4 blocks become a block of the mode 6 which is a block type having an 8×4 size (S512).

On the other hand, when the D (1, 2) is higher than the desired threshold Th2, it is determined whether D (1, 3) being a difference between the motion vectors of the modes 1 and 3 is less than the desired threshold Th1 (S508). When the D(1,3) is less than the desired threshold Th1, it is determined whether D (2, 4) is less than the desired threshold Th1 (S510). When the D (2, 4) is less than the desired threshold Th1, the 4 blocks become a block of the mode 5, which is a block type having a 4×8 size (S518).

On the other hand, when the D (3, 4) is higher than the desired threshold Th1, the D (1, 3) is higher than the desired threshold Th1, or the D (2, 4) is higher than the desired threshold Th1, the 4 blocks become a block of the mode 7, which is a block type having a 4×4 size (S516).

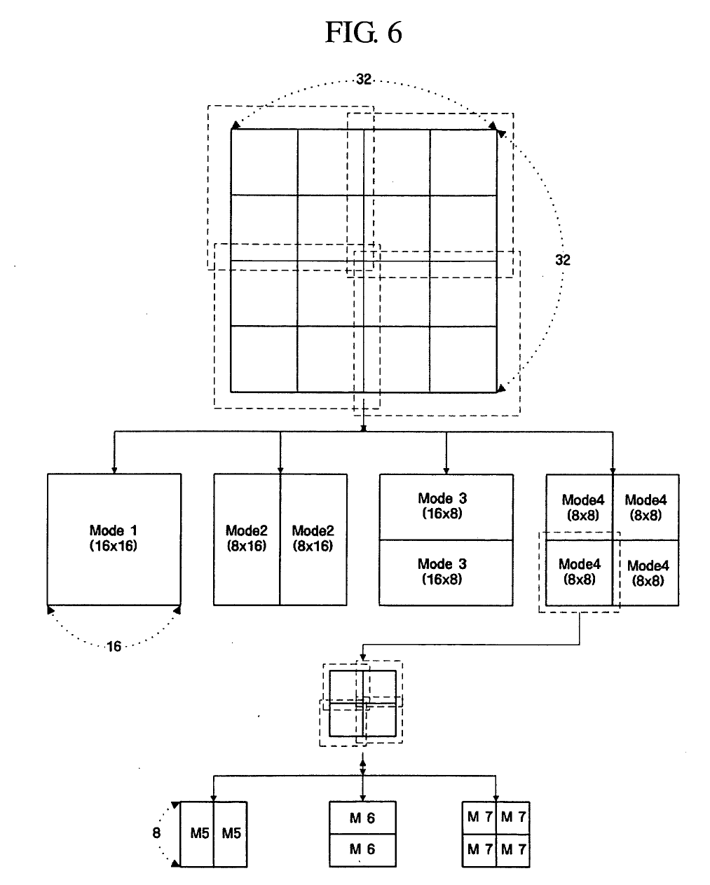

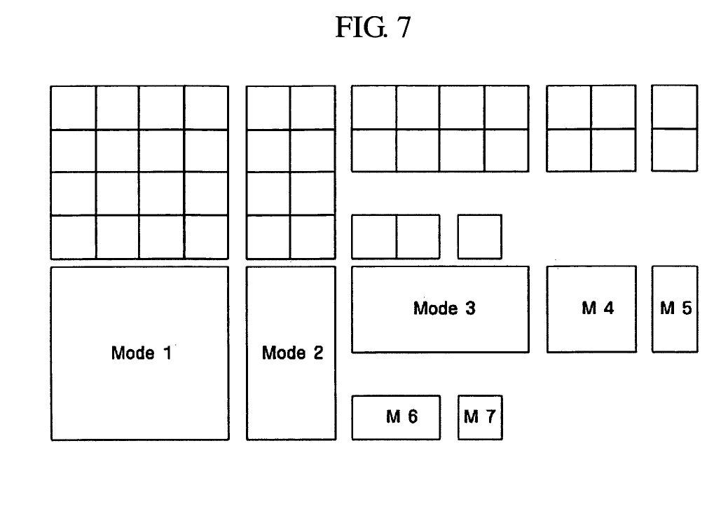

After the similarity has been determined as described above, the variable block mode establishment means 120 establishes a mode of a variable block according to the determined similarity (S406). The mode of the variable block is decided according to the determined similarity going down from the highest hierarchy to the lower hierarchies. FIG. 6 displays such processes, which is a view showing a process to decide a mode of a variable block in accordance with an embodiment of the present invention. And, FIG. 7 is a view showing a division of a block according to a mode of a variable block in accordance with an embodiment of the present invention.

As shown in FIG. 6, when a mode is decided starting from a block of the higher hierarchy having a 32×32 size, the block can be quartered so that 4 modes from mode 1 to mode 4 can be decided with respect to each of the blocks having a 16×16 size. When the mode 4 having an 8×8 size is established, the mode can be divided into 4 blocks of minimum units again so that a mode is established with respect to each of the blocks having an 8×8 size. In this case, there occur three cases, that is, mode 5, mode 6 and mode 7. That is, while a process to determine the similarity of motion vectors is performed going up starting from the lowest hierarchy to the higher hierarchies, a mode establishment of the variable block as described just above is performed on the basis of the determined similarity going down starting from the highest hierarchy to the lower hierarchies (S406).

The last step after the mode of the variable block has been established as described above is that the motion vector decision means 130 decides a motion vector with respect to the variable block to which the mode is established (S408). At this time, the motion vector of the variable block mode established in the variable block mode establishment means 120 is decided using the motion vectors of the lower hierarchy blocks constructing the block, and especially, it is desirable to make the decision using an intermediate value among the motion vectors of the lower hierarchy blocks constructing the block.

In case of using an average value, when the average value is subtracted from each of the motion vectors of 4 lower blocks, there remain difference signals with respect to all of the 4 blocks. However, in case of using the intermediate value, since one block having the intermediate value among the 4 lower blocks has 0 of the difference signal, there occurs an effect that this block has no difference in the picture, and differences among the difference signals with respect to the remaining 3 blocks become higher. It is because, as to both cases, the latter method using the intermediate value is said to produce less bits experimentally and statistically, when compression is performed by making a transformation in a transforming unit 40

On the other hand, the motion estimation method to calculate the motion vector may be performed using a high-speed motion estimation method. As it is to most motion picture compression algorithms, it is essential to compensate the motion estimation and the estimated motion in the process of removing the temporal redundancy. Since the process to estimate the motion requires many calculations, a microprocessor having an excellent arithmetic function is to be used in order to compress a real-time motion picture, and this becomes a factor to increase the cost of a motion picture coding apparatus. The present invention provides a more effective algorithm for the motion estimation to reduce the complication of the motion estimation significantly.

Although the exemplary embodiments and drawings of the present invention have been disclosed for illustrative purposes, those skilled in the art will appreciate that various substitutions, modifications, changes and additions are possible, without departing from the scope and spirit of the invention as disclosed in the accompanying claims.

While a picture compression algorithm using a method of estimating a motion of a hierarchy structure has a complication which increases in proportion to the number of redundancies of the hierarchy structure due to the redundancy of the hierarchy structure, its complication can be reduced significantly by predicting a motion of its higher hierarchy using only a motion estimation of the lowest part of the algorithm in accordance with the present invention constructed as described above.

Also, a complication of the method of compressing a motion picture of a hierarchy structure having a plurality of block sizes can be reduced by selecting a mode of the optimal block size on the basis of a motion vector with respect to the minimum unit and a cost occurring at that time without performing the motion estimation with respect to each mode each time.

Since such a method can be used together with an existing high-speed motion estimation method, it is possible to enhance advantages of the existing high-speed algorithm and to reduce an increase in complexity which occurs in a method that uses a variable block size of the hierarchy structure.

1. A method for a motion estimation using a variable block size of a hierarchy structure, the method comprising:
a first step of calculating motion vectors of minimum unit variable blocks;
a second step of determining similarities of the calculated motion vectors between minimum unit variable blocks in a higher hierarchy;
a third step of establishing a mode of a variable block according to the determined similarities; and
a fourth step of deciding a motion vector with respect to the mode established variable block.

2. The method according to claim 1, wherein the first step comprises;
calculating costs for the motion vectors of the minimum unit variable blocks; and
storing the calculated motion vectors and costs.

3. The method according to claim 2, wherein the second step comprises;
grouping the minimum unit variable blocks in an order of decreasing stored costs as grouped blocks; and
determining similarities of motion vectors between the grouped blocks.

4. The method according to claim 3, wherein when the motion vectors between the grouped blocks are similar as a result of the determining the similarities of the motion vectors between the grouped blocks, the second step further includes determining similarities of the motion vectors between the grouped blocks and other adjacent blocks having the same sizes as the grouped blocks, each of the grouped blocks being used as a unit.

5. The method according to claim 4, wherein, in the determination of the similarities of the motion vectors between the grouped blocks and other adjacent blocks, the motion vectors between the grouped blocks and other adjacent blocks are determined as similar when a vector difference of the motion vectors of variable blocks that are subjects of the determination of the similarities of the motion vectors between the grouped blocks and other adjacent blocks, is less than or equal to a desired threshold.

6. The method according to claim 1, wherein the third step is a step of establishing the mode of the variable block according to the determined similarities starting from a highest hierarchy to lower hierarchies.

7. The method according to claim 1, wherein the fourth step is a step of deciding the motion vector of the mode of the variable block established in the third step using the motion vectors of lower hierarchy blocks constructing the variable block established in the third step.

8. The method according to claim 7, wherein the fourth step is a step of deciding the motion vector of the mode of the variable block established in the third step using an intermediate value of the motion vectors of the lower hierarchy blocks constructing the variable block established in the third step.

9. The method according to claim 1 wherein the method for a motion estimation to calculate the motion vector is a method for a high-speed motion estimation.

10. An apparatus for a motion estimation using a variable block size of a hierarchy structure, comprising:
motion vector calculating means for calculating motion vectors of minimum unit variable blocks;
variable block mode establishment means for determining similarities of the calculated motion vectors between minimum unit variable blocks in a higher hierarchy, and establishing a mode of a variable block according to the determined similarities; and
motion vector decision means for deciding the motion vector with respect to the mode established variable block.

11. The apparatus according to claim 10, wherein the motion vector calculating means calculates costs for the motion vectors of the minimum unit variable blocks and stores the calculated motion vectors and costs.

12. The apparatus according to claim 11, wherein the variable block mode establishment means makes a grouping of the minimum unit variable blocks in an order of decreasing stored costs as grouped blocks, and determines similarities of motion vectors between the grouped blocks.

13. The apparatus according to claim 12, wherein the variable block mode establishment means determines the similarities of the motion vectors between the grouped blocks and other adjacent blocks having the same sizes as the grouped blocks when the motion vectors between the grouped blocks are similar as a result of determining the similarities of the motion vectors between the grouped blocks, each of the grouped blocks being used as a unit.

14. The apparatus according to claim 13, wherein, in the determination of the similarities of the motion vectors between the grouped blocks and other adjacent blocks, the motion vectors between the grouped blocks and other adjacent blocks are determined as similar when a vector difference of the motion vectors of variable blocks that are subjects of the determination of the similarities of the motion vectors between the grouped blocks and other adjacent blocks, is less than or equal to a desired threshold.

15. The apparatus according to claim 10, wherein the variable block mode establishment means establishes the mode of the variable block according to the determined similarities starting from a highest hierarchy to lower hierarchies.

16. The apparatus according to claim 10, wherein the motion vector decision means decides the motion vector of the mode of the variable block established in the variable block mode establishment means using the motion vectors of lower hierarchy blocks constructing the variable block established in the variable block mode establishment means.

17. The apparatus according to claim 16, wherein the motion vector decision means decides the motion vector of the mode of the variable block established in the variable block mode establishment means using an intermediate value of the motion vectors of the lower hierarchy blocks constructing the variable block established in the third step.
